(19) United States
(12) Patent Application Publication
(10) Pub. No.: US 2026/0174270 A1
(43) Pub. Date: Jun. 25, 2026

(54) DISPENSING GROUP FOR DISPENSING HOT WATER AND STEAM, COFFEE MACHINE, RECIRCULATION METHOD, AND METHOD FOR DISPENSING HOT WATER

(71) Applicant: ILLYCAFFE' S.P.A., Trieste (IT)

(72) Inventors: Christian BRACICH, Trieste (IT); Riccardo PIRAS, Trieste (IT); Francesco CESCUTTI, Trieste (IT); Marco FERRARI, Trieste (IT); Eugenio RONCALI, Trieste (IT)

(21) Appl. No.: 19/121,234

(22) PCT Filed: Oct. 5, 2023
(86) PCT No.: PCT/IB2023/060009

§ 371 Date: Apr. 15, 2025

(30) Foreign Application Priority Data
Oct. 18, 2022 (IT) 102022000021441

(51) Int. Cl. A47J 31/40; A47J 36/24; B67D 1/00; B67D 1/08

(52) U.S. Cl. CPC A47J 31/407; A47J 36/2466; B67D 1/0021; B67D 1/0884; B67D 1/0888

(57) ABSTRACT

A dispensing group for dispensing hot water and steam has a first fluidic conduit having a main branch which receives water and allows a flow of water towards a hot water dispensing opening, a first heating device for heating the water flowing into the main branch, a second fluidic conduit which receives water and allows a flow of water towards a steam dispensing opening, and a second heating device for heating the water flowing into the second fluidic conduit to generate steam. The first fluidic conduit has a recirculation branch which originates from, and is fluidically reintroduced into the main branch upstream of the first heating device. The first fluidic conduit and the second fluidic conduit are fluidically and thermally separate from each other. A coffee machine includes a coffee dispensing unit and the dispensing group.

### FIELD OF APPLICATION

The present invention relates to a dispensing group for dispensing hot water and steam, for example and not necessarily, for a coffee machine.

In particular, the present invention belongs to the field of the distribution of hot beverages, at a professional level, e.g., for coffee shops, restaurants, and automatic vending machines or, at a domestic level, e.g., for domestic use.

Integrated hot water and steam distribution systems in the same dispensing group are known in the art. Generally, the known dispensing groups consist of a single fluidic conduit, which supplies two dispensing nozzles, for alternately dispensing hot water and steam.

Typically, in fact, known dispensing groups do not allow dispensing hot water or dispensing steam at different times because, as they generally have a single fluidic conduit supplying both dispensing operations, the water flow rates in the circuit are not sufficient to supply both dispensing operations, and it is simultaneously complicated and costly to heat and pump water in the same fluidic conduit at two different temperatures.

Moreover, boilers or storage boilers are often used in the known dispensing systems, in which great amounts of heated water are stored, in the same volume, which remains in the respective storage tank for a long time before being dispensed.

It is known that such systems can develop bacteriological loads, and even if the problem is under control and the known boilers largely respect the health and safety standards, such systems require a specific control of the microbiological risk.

Moreover, such a drawback forces users to perform continuous and frequent cleaning cycles, with consequent waste in terms of time and resources.

### SOLUTION OF THE INVENTION

Thus, the need is strongly felt to provide a hot water and steam dispensing group capable of overcoming the drawbacks typical of the state-of-the-art.

In particular, it is the object of the present invention improve the steam and water dispensing efficiency, and in particular to allow simultaneously dispensing hot water and steam.

Such a need is met by a dispensing group, a coffee machine, a recirculation method, and a method for dispensing hot water according to the appended claims. The claims dependent thereon describe preferred or advantageous embodiments of the invention, involving further advantageous aspects.

### DESCRIPTION OF THE DRAWINGS

The features and advantages of the dispensing group, the coffee machine, the recirculation method, and the dispensing method will however become apparent from the following description of some preferred embodiments thereof, given by way of non-limiting indications, with reference to the accompanying drawings, in which:

FIG. 1 shows a fluidic circuit diagram of a dispensing group according to an embodiment of the present invention;

FIG. 2 shows a fluidic circuit diagram of a first fluidic conduit of a dispensing group according to an embodiment of the present invention;

FIG. 3 shows a fluidic circuit diagram of a second fluidic conduit of a dispensing group according to an embodiment of the present invention;

FIG. 4 shows a perspective view of a dispensing group according to an embodiment of the present invention;

FIG. 5a shows a lateral perspective view of a first fluidic conduit of a dispensing group according to an embodiment of the present invention;

FIG. 5b shows a further lateral perspective view of the first fluidic conduit in FIG. 5a;

FIG. 5c shows a view from above of the first fluidic conduit in FIG. 5a;

FIG. 6 shows a lateral perspective view of a second fluidic conduit according to an embodiment of the present invention;

FIG. 7 shows a perspective view of a dispensing group of the present invention, in an embodiment of the present invention;

FIG. 8 shows a perspective view of the dispensing group in FIG. 7, depicting the collection conduit arranged at a cup holder unit, according to an embodiment of the present invention;

FIG. 9 shows a perspective view of a coffee machine according to an embodiment of the present invention;

FIG. 10 shows a fluidic circuit diagram of a dispensing group according to a further embodiment of the present invention.

### DETAILED DESCRIPTION

With reference to the aforesaid figures, reference numeral 1 globally denotes a dispensing group 1 for dispensing hot water and steam.

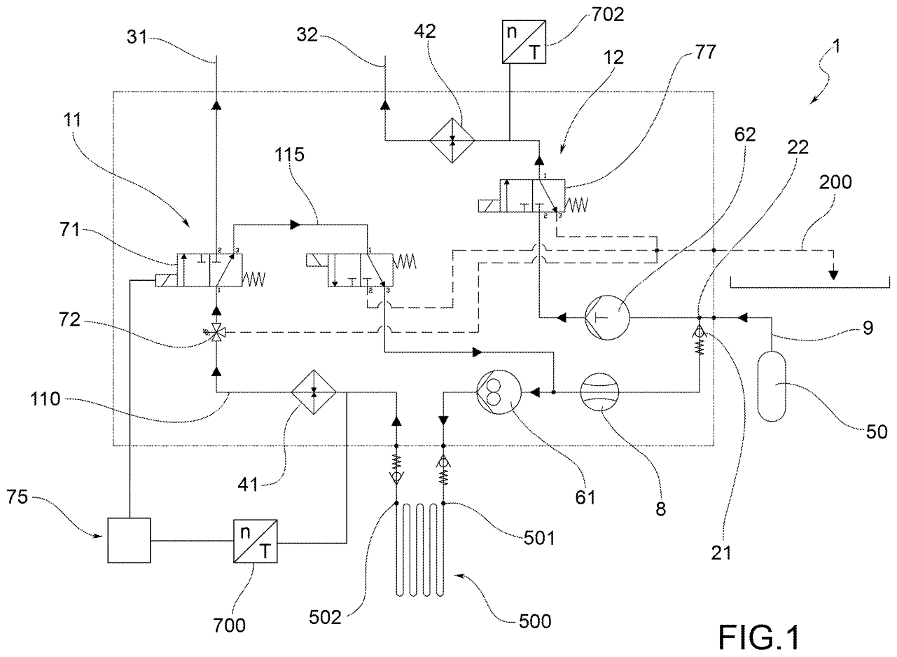

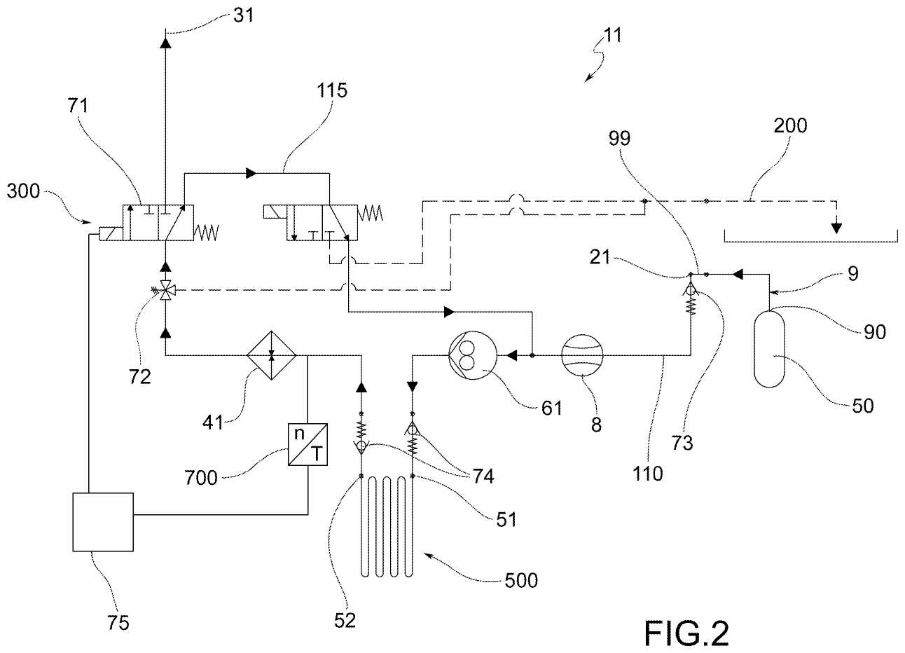

According to the invention, and with reference to the illustrative embodiment in FIG. 1, the dispensing group 1 comprises a first fluidic conduit 11 comprising a main branch 110, extending between a first water inlet opening 21 and a hot water dispensing opening 31. FIG. 2 shows an embodiment of such a first fluidic conduit 11 insulated from the remaining part of the dispensing group.

The main branch 110 is suitable for receiving water through said first water inlet opening 21 and for allowing such water to flow towards the hot water dispensing opening 31.

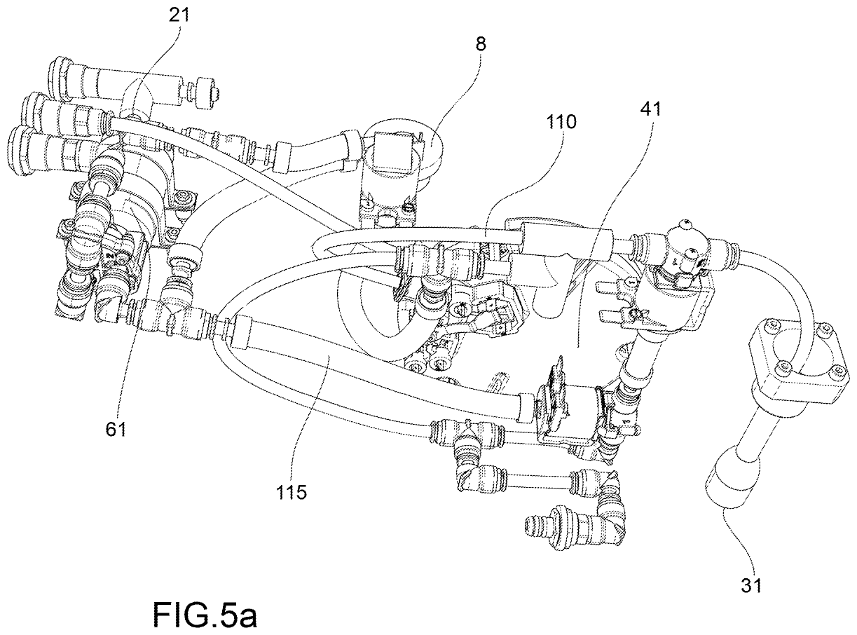

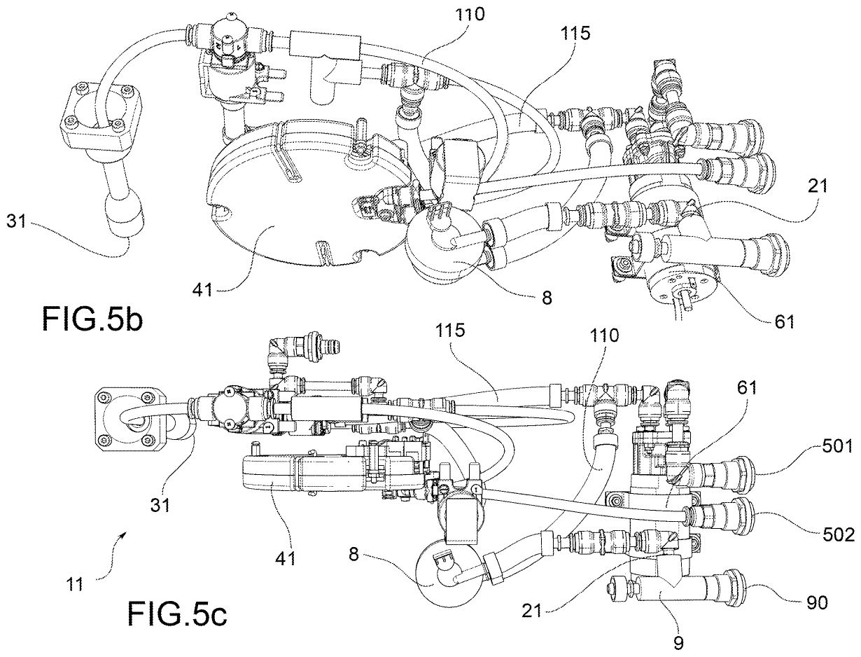

Preferably, as shown, for example, in FIGS. 5a, 5b and 5c, the hot water dispensing opening 31 is connected to, or obtained in a hot water outlet nozzle, designed to direct a flow of hot water to a collection container, e.g., a cup or a glass.

Moreover, according to the invention, the dispensing group 1 comprises a first heating device 41, operatively connected to the main branch 110 and suitable for heating the water flowing into such a main branch 110, before it reaches the hot water dispensing opening 31.

In an embodiment of the invention, the first heating device 41 is installed close to the hot water dispensing opening 31.

Preferably, the first heating device 41 is an instantaneous heater, even more preferably, it is a heater of the FTH (Flow Through Heater) type.

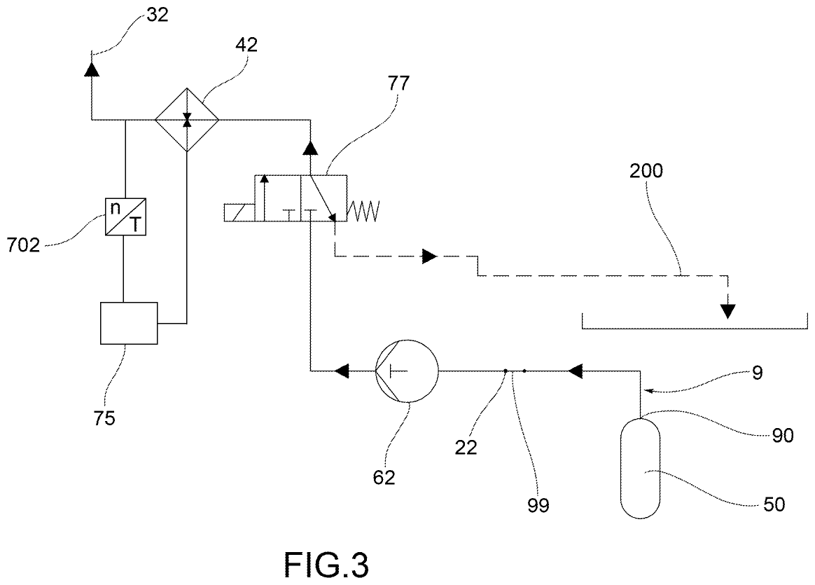

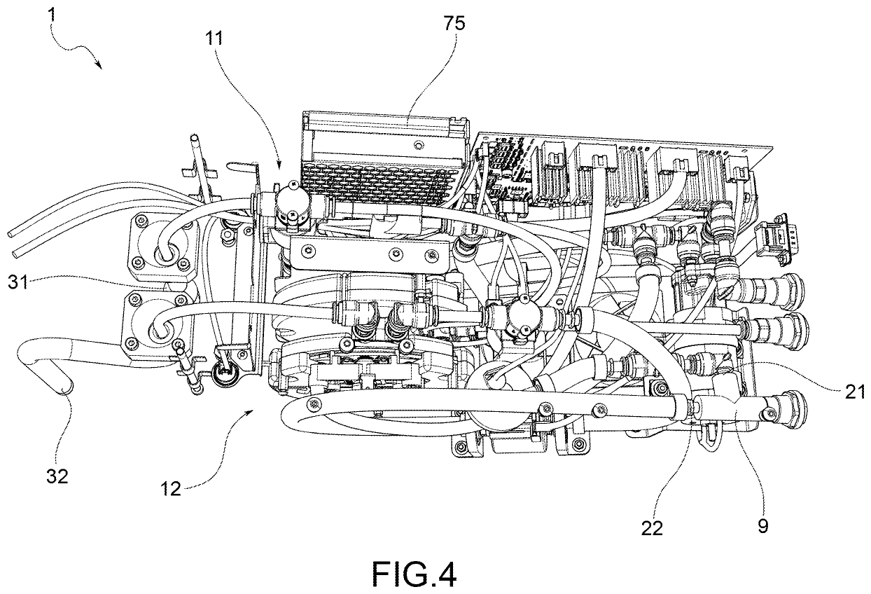

According to the invention, the dispensing group 1 also comprises a second fluidic conduit 12 extending between a second water inlet opening 22 and a steam dispensing opening 32. FIG. 3 shows an embodiment of such a second fluidic conduit 12 isolated from the remaining part of the dispensing group.

Such a second fluidic conduit 12 is suitable for receiving water through such a second water inlet opening 22 and allowing such water to flow towards the steam dispensing opening 32.

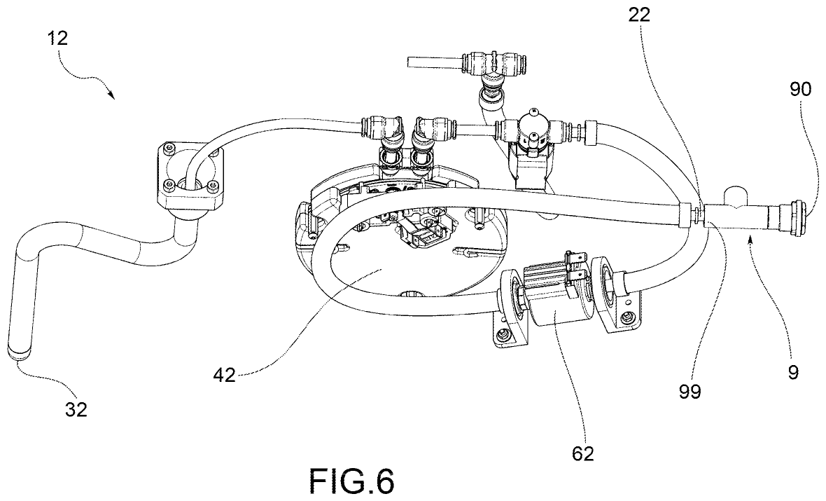

Preferably, as shown, for example, in FIG. 6, the steam dispensing opening 32 is connected to, or obtained in a steam outlet nozzle, designed to direct a flow of steam into a fluid contained in a collection container, e.g., a cup or a glass, or a pan, containing milk.

The dispensing group 1 further comprises a second heating device 42, operatively connected to the second fluidic conduit 12 and suitable for heating the water flowing into said second fluidic conduit 22 to generate steam, before it reaches the steam dispensing opening 32.

In an embodiment of the invention, the second heating device 42 is installed close to the steam dispensing opening 32.

Preferably, the second heating device 42 is an instantaneous heater, even more preferably, it is a heater of the FTH (Flow Through Heater) type.

According to an aspect of the present invention, as shown in the illustrative embodiments in FIGS. 1, 2 and 10, the first fluidic conduit 11 comprises a recirculation branch 115, which fluidically originates from said main branch 110 downstream of the first heating device 41 and upstream of the hot water dispensing opening 31 and which is fluidically reintroduced into said main branch 110, upstream of said first heating device 41.

In this document, the expressions “upstream” and “downstream” are always used with reference to the flow direction of water from the first and second water inlet openings 21, 22 towards the hot water dispensing opening 31 or towards the steam dispensing opening 32, respectively.

Moreover, according to a further aspect of the invention, the first fluidic conduit 11 and the second fluidic conduit 12 are fluidically and thermally each separate from other in the path thereof respectively between the first water inlet opening 21 and the hot water dispensing opening 31 and between the second water inlet opening 22 and the steam dispensing opening 32.

In other words, according to the present invention, the dispensing group 1 comprises two fluidic conduits, which are kept fluidically and thermally separate from each other, the first fluidic conduit 11, for producing and dispensing hot water, and the second fluidic conduit 12, for producing and dispensing steam.

The definition “fluidically separate” is understood to mean that such first and second fluidic conduits 11, 12 do not have fluidic nodes in common along the respective path thereof. That is, for example, the water entering the first fluidic conduit 11 cannot reach the second fluidic conduit 12, and vice versa.

The definition “thermally separate” is understood to mean that such first and second fluidic conduits 11, 12 do not directly influence each other, i.e., they do not contribute directly to heating or, more generally, to varying the temperature of the other, or of the water flowing therein. In other words, for example, the first heating device 41 only thermally influences the water passing in the first fluidic conduit 11. Likewise, the second heating device 42 only thermally influences the water passing in the second fluidic conduit 12.

In an embodiment, illustrated in detail in the document below, the second fluidic conduit 12 is only indirectly influenced-passively-along a heated stretch 120 by the preheated hot water flowing in the first fluidic conduit 11 (in particular, stored in the collection conduit 500, which will be described below in this document).

Moreover, according to an advantageous embodiment, the first heating device 41 and the second heating device 42 are completely disconnected from each other both fluidically and thermally.

In an advantageous embodiment, the first fluidic conduit 11 comprises a first pump 61, preferably a rotary pump, installed upstream of the heating devices 41 and suitable for pushing water into the main branch 110 towards said heating devices 41.

In a particularly advantageous embodiment, the recirculation branch 115 is reintroduced into the main branch 110 upstream of said first pump 61.

In other words, according to an advantageous aspect, the present invention provides that the first fluidic conduit 11 for dispensing hot water is equipped with a recirculation, i.e., it is suitable for recirculating preheated water by means of the first heating device 41, through said recirculation branch 115, and reintroducing such a preheated water into the main branch 110, preferably upstream of the first pump 61.

Advantageously, by virtue of the presence of the recirculation branch, which always provides a certain flow of preheated water for the dispensing, the dispensing group according to the present invention is capable of significantly reducing the time for dispensing hot water at a high temperature.

For example, by means of the first heating device 41 it is possible to preheat water to about 60° C. and send it into recirculation in the recirculation branch 115, subsequently reaching the main branch 110 again.

Thereby, when the dispensing of hot water, typically boiling water, is requested, preferably about 90-95° C., for preparing hot beverages, such as teas or herbal drinks, it is possible to apply a reduced final heating to the previously preheated water, by means of the first heating device 41.

Advantageously, such a feature of the dispensing group also allows utilizing heating devices with reduced powers, as compared to the typical heaters of the prior art, at the same required dispensing temperature.

Moreover, by virtue of the presence of the first pump 61 it is advantageously possible to regulate the hot water dispensing time by acting both on the power of the first heating device 41 and on the power of the first pump 61.

In an embodiment of the invention, with reference to FIG. 2, the recirculation branch 115 fluidically originates from the main branch 110 downstream of the first heating device 41 and upstream of the hot water dispensing opening 31 at an emission node 300 of the main branch 110.

In a constructional variant, the first fluidic conduit 11 comprises a flow regulating element 71 at said emission node 300, suitable for regulating the water flow from the main branch 110 towards the hot water dispensing opening 31 or towards the recirculation branch 115.

In an advantageous embodiment, such a flow regulating element 71 is a three-way valve.

In a preferred embodiment, the dispensing group 1 comprises an electronic control unit 75 operatively connected to said flow regulating element 71 and configured to process and send, to said flow regulating element 71:
a dispensing signal for allowing water to pass from the main branch 110 towards the hot water dispensing opening 31; or
a recirculation signal for allowing water to pass from the main branch 110 towards the recirculation branch 115.

According to a further embodiment, the electronic control unit 75 is connected to a user interface by means of which a user can send, to the dispensing group, a hot water dispensing command, and he/she can also manually command the flow regulating element 71 to regulate the passage of water towards the hot water dispensing opening or towards the recirculation branch.

In an embodiment, the dispensing group 1 comprises a tank 50, preferably containing water at room temperature or cold water, fluidically connected to the first fluidic conduit 11 by means of the first water inlet opening 21, and to the second fluidic conduit 12 by means of the second water inlet opening 22.

In other words, in such an embodiment, each fluidic conduit 11, 12 is directly connected to the tank 50 by means of the respective water inlet opening 21, 22.

In an embodiment, for example shown in FIGS. 1, 2 and 3, the dispensing group 1 comprises a connection conduit 9 having a first end 90, fluidically connected to the tank 50, which is suitable for containing water, and a second end 99, fluidically connected to the first fluidic conduit 11 and to the second fluidic conduit 12 by means of the first 21 and the second water inlet opening 22, respectively. Said connection conduit 9 is suitable for indirectly connecting the first fluidic conduit 11 and the second fluidic conduit 12 to the tank 50.

Preferably, the first opening 21 and the second water inlet opening 22 are therefore both connected to the same second end 99 of the connection conduit 9.

Preferably, a regulating valve is installed at such a second end 99, which is suitable for regulating the flow of water from the tank 50 towards the first fluidic conduit 11 through said first water inlet opening 21, and/or towards the second fluidic conduit 12 through said second water inlet opening 22.

In an advantageous embodiment, the regulating valve is suitable for allowing the flow in both the first fluidic conduit 11 and the second fluidic conduit 12.

Thereby, advantageously, also by virtue of the separation between the two fluidic conduits 11 and 12 and by virtue of the presence of the thermally separate first heating device 41 and second heating device 42, the simultaneous dispensing of hot water is allowed by means of the hot water dispensing opening 31, and steam by means of the steam dispensing opening 32.

Moreover, a non-return valve 73 is preferably installed at the first water inlet opening 21, suitable for blocking the return of the water entering the first fluidic conduit 11, towards the tank 50 or towards the second fluidic conduit 12.

In an embodiment, the second fluidic conduit 12 comprises a second pump 62, preferably a volumetric pump, installed upstream of the second heating device 42 and suitable for pushing water into the second fluidic conduit towards said second heating device 42.

In an embodiment, the dispensing group 1 comprises one or more steam temperature sensors 702, installed on the second fluidic conduit 12 and configured to detect the temperature of the water in the second fluidic conduit 12, upstream of the second heating device 42, close thereto.

Preferably, the electronic control unit 75 is connected to said one or more steam temperature sensors 702 and is configured to regulate the flow rate passing from the second heating device 42 as a function of the temperature detected by said one or more steam temperature sensors 702.

Preferably, the flow rate passing from the second heating device 42 is regulated by acting on the power of the second pump 62.

In a constructional variant, the dispensing group 1 further comprises a flow rate measurer 8, e.g., a flow meter installed on the first fluidic conduit 11.

Preferably, such a flow rate measurer 8 is installed on the main branch 110, even more preferably, upstream of the first pump 61.

In an embodiment, the recirculation branch 115 is reintroduced into the main branch 110 downstream of said flow rate measurer 8 and upstream of the first pump 61.

In a constructional variant, the dispensing group comprises a flow rate measurer 8 installed on the connection conduit 9.

In an advantageous embodiment, the first fluidic conduit 11 and the second fluidic conduit 12 are separate at least from a node downstream of the flow rate measurer 8.

In a particularly advantageous embodiment, with reference to FIGS. 1 and 2, the main branch 110 comprises a collection conduit 500, between the first pump 61 and the first heating device 41, suitable for accumulating water preheated by the heating device 41 and reintroduced into the main branch 110 by means of the recirculation branch 115.

The collection conduit 500 being at least partially thermally conductive to allow the transmission of heat of the heated hot water stored in the collection conduit 500, towards the environment.

In other words, the collection conduit 500 is at least partially not insulated, i.e., it comprises at least one exchange wall 550 suitable for allowing the heat exchange between the water heated inside the collection conduit 500 and the environment, through said exchange wall 550.

More generally, the expression “towards the environment” is understood to mean “towards the outside of the collection conduit”, i.e., towards any chamber, or element, arranged outside said conduit.

Preferably, the whole outer wall of the collection conduit is suitable for allowing the heat exchange, i.e., the whole collection conduit is not insulated.

Advantageously, by virtue of such a feature, the heated water stored in the collection conduit 500 can be exploited for a dual purpose: on the one hand, a certain flow of preheated water is provided to allow hot water to be dispensed more quickly at a high temperature, on the other hand, the use of the heat of combustion of the water heated in the collection conduit 500 is allowed to transmit heat passively to elements close to such a collection conduit, which need to be heated, like other fluidic conduits or further elements of the dispensing group, such as cup holder units, for example, as is better explained in the document below.

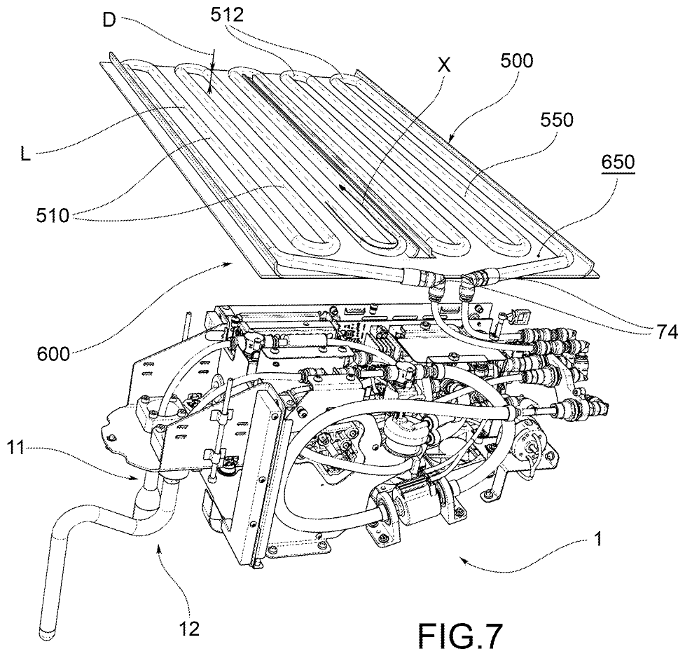

In an advantageous variant and with reference to FIG. 7, the collection conduit 500 is a tube extending for a collection length L along a prevalent flow direction X and having a cross-section on a plane transversal to said prevalent flow direction X, which is defined by a transversal dimension D, wherein said collection length L is much greater than said transversal dimension D.

For example, the collection conduit 500 is a tube having a collection length L along the prevalent flow direction X and having a circular cross-section defined by a diameter D, wherein the length L is much greater than the diameter D. In other words, the collection conduit is a long and narrow tube.

Preferably, the collection length L is at least ten times the transversal dimension D, preferably at least fifty times the transversal dimension D, even more preferably, at least one hundred times the transversal dimension D.

Clearly, prevalent flow direction X does not only mean a linear direction, but it also refers to a sinuous direction, e.g., to a curved, or broken, or mixed trajectory, comprising linear, and/or curved and/or broken stretches, which follows the direction of the water flow in the conduit.

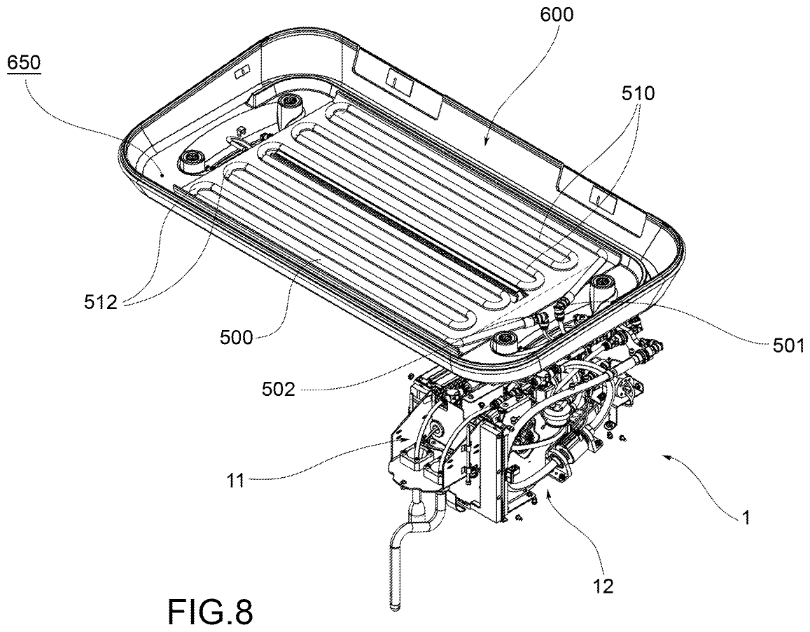

In a preferred constructional variant, with reference to FIGS. 7 and 8, the collection conduit 500 has a snakelike development, i.e., it forms a fluidic serpentine, comprising linear stretches 510 interspersed with curvilinear stretches 512.

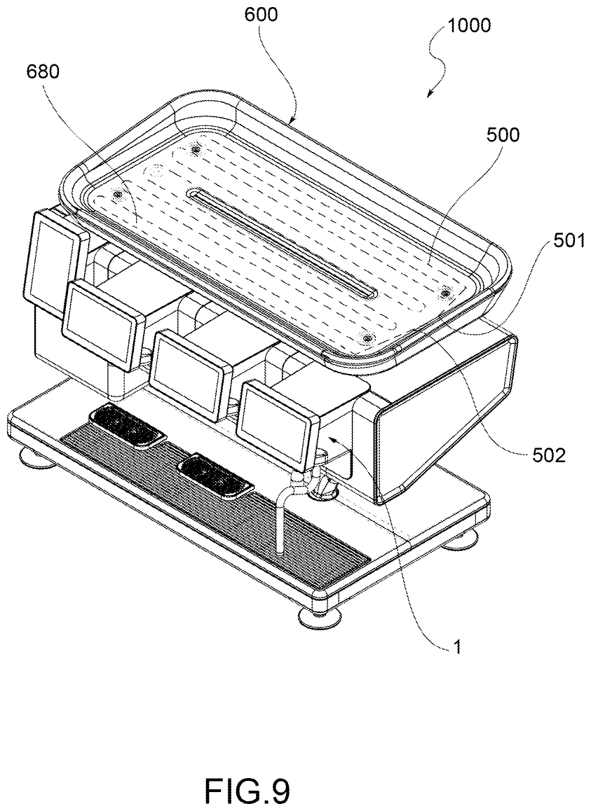

Moreover, in a particularly advantageous embodiment shown for example in FIGS. 8 and 9, the dispensing group 1 comprises a cup holder unit 600, e.g., a tray or a cup holder plate, positioned close to the collection conduit 500 so that the heating of at least one surface of said cup holder unit 600 is allowed by means of the transmission of heat from the water contained in said collection conduit 500 towards said cup holder unit 600.

In an embodiment, such a cup holder unit 600 comprises at least one contact wall in contact with said collection conduit 500, preferably in contact with the aforesaid exchange wall 550.

In an embodiment, such a cup holder unit 600 comprises therein a heating chamber 650, said heating chamber 650 being suitable for accommodating said collection conduit 500.

Preferably, such a heating chamber 650 is closed at the top by means of a cup holder plate 680, so as to conceal the collection conduit 500 from the user's sight. Such a cup holder plate 680 is suitable for resting mugs, cups, glasses, to be heated.

In an embodiment, the collection conduit 500 extends from a first end 501 to a second end 502.

Preferably, the first fluidic conduit 11 at said first and second ends 501, 502, comprises non-return valves 74 suitable for being opened and closed, respectively, for allowing or blocking the passage of preheated water from the recirculation branch towards the collection conduit 500 and from the collection conduit 500 towards the first heating device 41.

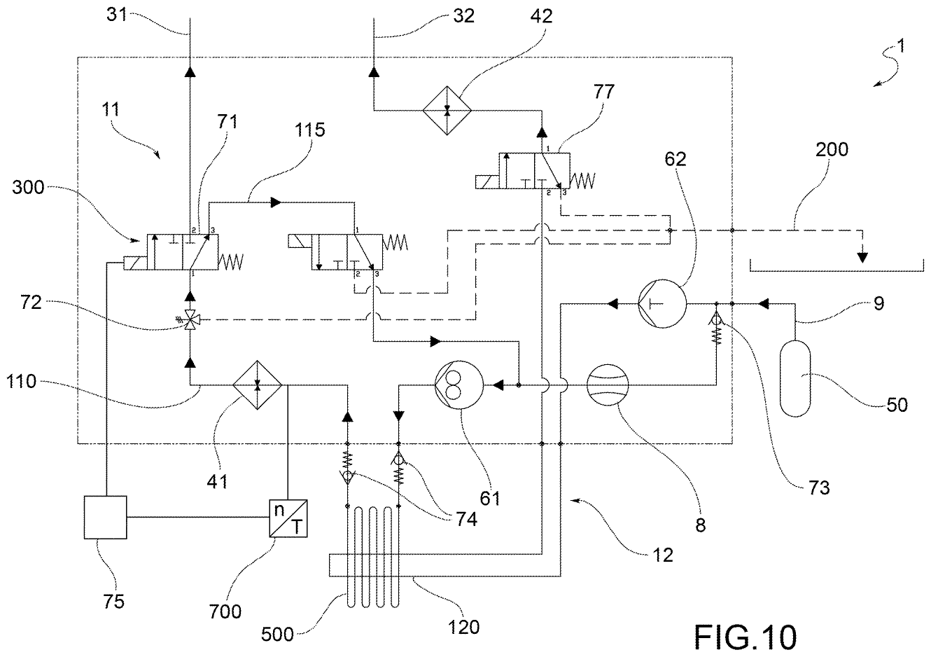

In an embodiment of the invention, shown in the implementation example in FIG. 10, the second fluidic conduit 12, designed for producing steam, comprises a preheating stretch 120 passing close to the collection conduit 500.

In such an embodiment, the collection conduit 500 is suitable for allowing the heat transfer from the water preheated therein, to the preheating stretch 120, so as to also allow a minimum preheating of the water flowing into the second fluidic conduit 12.

Thereby, the dispensing of steam is also facilitated and, at the same final dispensing temperature, it allows using a heater with reduced power if compared to the heaters used in the prior art for generating steam.

In an embodiment, the dispensing group 1 further comprises an overpressure relief valve 72 installed on the first fluidic conduit 11, preferably downstream of the first pump 61, even more preferably downstream of the collection conduit 500.

In an embodiment, the dispensing group comprises a discharge branch 200, fluidically connectable to the first fluidic conduit 11 and/or to the second fluidic conduit 12 for allowing water and/or steam to be released, if necessary.

Preferably, such an overpressure relief valve 72 is suitable for regulating the flow of hot water from the main branch 110 towards the hot water dispensing opening 31, or towards the recirculation branch 115 or towards the discharge branch 200, where necessary.

In an embodiment, the dispensing group 1 comprises a steam regulating element 77 installed on the second fluidic conduit 12, preferably downstream of the second pump 62.

Preferably, such a steam regulating element 77 is suitable for regulating the water flow towards the steam dispensing opening 32, preferably flowing from the second heating device 42, or towards the discharge branch 200.

It is apparent that the dispensing group claimed is suitable for operating as an independent unit or for being integrated into household appliances with other functionalities, e.g., integrated into a domestic or professional coffee machine.

With reference to FIG. 9, the present invention also relates to a coffee machine 1000 comprising a coffee dispensing unit and a dispensing group 1 for dispensing hot water and steam according to the present invention.

The present invention further relates to a recirculation method comprising the following steps:
a) providing a dispensing group 1 according to an embodiment of the present invention;
b) allowing water to pass into the main branch 110 from the first water inlet opening 21 towards the hot water dispensing opening 31;
c) by means of the first heating device 41, preheating the water flowing into said main branch 110 to generate an amount of water preheated at a predetermined preheating temperature;
d) blocking the passage of said amount of preheated water towards the hot water dispensing opening 31 and allowing said amount of preheated water to pass from the main branch 110, downstream of the first heating device 41, into the recirculation branch 115;
e) reintroducing said amount of preheated water from the recirculation branch 115 into the main branch 110 upstream of said first heating device 41.

The present invention n also relates to a method of dispensing hot water, comprising the following steps:
f) performing a method of recirculating preheated water according to the present invention;
g) providing an electronic control unit 75 operatively connected to the dispensing group 1;
h) by means of the electronic control unit 75, preferably, in response to a hot water dispensing command sent by a user, preferably sending, by means of a user interface, a hot water dispensing signal to the dispensing group 1;
i) as a function of said hot water dispensing signal, by means of the first heating device 41, performing a final heating of a volume of water to be dispensed, comprising the amount of preheated water reintroduced into the main branch 110 and/or an amount of unheated water entering the main branch 110 from the first water inlet opening 21 to bring it to a predetermined dispensing temperature;
j) allowing water heated at the predetermined dispensing temperature to pass through the hot water dispensing opening 31.

It is apparent that, depending on the volume of water required for the dispensing, the amount of preheated water might, or might not be enough to ensure the dispensing of such a volume. It is apparent that the method provides that, at the same time as the dispensing, the main branch 110 continues to receive water entering through the first water inlet opening 21.

Thereby, on the one hand, the constant filling of the main branch 110 is advantageously ensured, avoiding the formation of air bubbles, which would be detrimental to the operation of the heating device. Advantageously, at the same time, such a system theoretically allows the dispensing group to dispense any volume of hot water without stoppages.

Therefore, in an embodiment, the first heating device 41 must be suitable for performing the final heating of a certain amount of water, which is at a preheating temperature, e.g., 60° C., and of a certain amount of water, which is at a reduced temperature instead, e.g., at room temperature, and bring both such amounts of water to a predetermined dispensing temperature, e.g., 90° C.

In an embodiment, step i) comprises the following sub-steps:
i1) providing a temperature sensor 700 suitable for detecting the temperature of the water at the first heating device 41, operatively connected to the electronic control unit 75;
i2) by means of the electronic control unit 75, making a comparison between the temperature detected by said temperature sensor and a minimum preheating temperature;
i3) as a function of said comparison, performing one of the following actions:
i31) if the temperature detected is greater than or equal to said minimum preheating temperature, heating the water by means of the first heating device 41 on a maximum water flow rate, to bring it to the dispensing temperature;
i32) if the temperature detected is less than the minimum preheating temperature, heating the water by means of the first heating device 41 on a water flow rate that is lower than the maximum flow rate, to bring it to the dispensing temperature.

In other words, with the same power, the first heating device 41 is suitable for heating a reduced flow of water—and consequently producing a slower exiting flow of hot water—when the temperature of the water to be heated is below the minimum preheating temperature, and, on the contrary, it is suitable for heating a greater flow of water—and consequently, producing a faster exiting flow of hot water—when the temperature of the water to be heated is at least at the minimum preheating temperature.

Clearly, this is due to the fact that, with the same power and working with previously preheated water, the first heating device 41 must perform thereon a reduced heating, and therefore, advantageously, it is able to process a greater flow at the dispensing temperature in a shorter time.

Preferably, after step j), the method of dispensing hot water includes performing the recirculation method again, so as to immediately provide an amount of preheated water for a subsequent dispensing.

Preferably, moreover, the recirculation is also started after not using the dispensing group for a certain time, so as to prevent the deposit and growth of bacterial agents or pathogens in the conduit.

It is apparent that the recirculation is preferably started during the non-working steps of the dispensing group, i.e., when the dispensing of hot water and steam is not required.

It is equally apparent that the method of dispensing hot water can take place at the same time as a method of dispensing steam, consisting of the following steps:
a) providing a hot water and steam dispensing group 1 according to the present invention;
m) dispensing water into the second fluidic conduit 12 through the second water inlet opening 22;
n) by means of the second heating device 42, heating the water in the second fluidic conduit 12 at a steam dispensing temperature, so as to generate steam;
o) dispensing steam by means of the steam dispensing opening 32.

Innovatively, the present invention solves the drawbacks of the typical dispensing groups of the prior art.

Advantageously, by virtue of the technical features described in this document, in fact, the dispensing group according to the present invention allows significantly improving the efficiency of the dispensing system for dispensing water and steam.

Advantageously, by virtue of the presence of two fluidic branches, which are completely fluidically and thermally separate, the dispensing group according to the present invention allows simultaneously dispensing hot water and steam at the standard dispensing flow rates.

According to a further advantage, the provision of two fluidically and thermally separate fluidic branches allows operating on the parameters for dispensing hot water and steam (such as, the flow rate, temperature, pressure, dispensing speed, for example) completely independently.

Clearly, this allows regulating each dispensing according to the user's specific needs without influencing the parameters of the dispensing, taking place in parallel.

According to an even further advantage, by virtue of the presence of a recirculation branch in the fluidic conduit for dispensing the hot water, the hot water dispensing time is reduced. In other words, the possibility of always providing a certain amount of preheated water, allows applying only a minimum final heating, to bring such water to the dispensing temperature and consequently, with the same power as the heating device, the present dispensing group allows dispensing a greater flow of water at the dispensing temperature in a shorter time.

Thereby, the delay-waiting time-between the dispensing command and the effective dispensing is delayed.

Moreover, in relation to such an advantage, note the convenience of being able to use a heater with reduced power with respect to the heaters used in the prior art, for providing hot water at the same dispensing temperature.

Finally, advantageously, the use of a fluidic collection conduit in the fluidic hot water dispensing branch, suitable for transmitting heat by conduction, allows utilizing the heat of combustion of the preheated water stored in such a collection conduit for heating further parts of the dispensing group or the coffee machine, e.g., for heating a cup holder plate, so as to provide preheated mugs and cups ready to receive the hot beverages.

It is apparent that, in order to meet specific needs, those skilled in the art may make variations to the embodiments of the aforesaid dispensing group and the aforesaid coffee machine, or replace elements with others which are functionally equivalent.

Such variations are also contained within the scope of protection as defined by the following claims. Moreover, each variation described as belonging to a possible embodiment can be implemented irrespective of the other variations described.

### LIST OF REFERENCE SIGNS

1 dispensing group
11 first fluidic conduit
12 second fluidic conduit
110 main branch
115 recirculation branch
120 preheating stretch
21 first water inlet opening
22 second water inlet opening
200 discharge branch
31 hot water dispensing opening
32 steam dispensing opening
300 emission node
41 first heating device
42 second heating device
50 tank
500 collection conduit
501 first end
502 second end
510 linear stretches
512 curvilinear stretches
550 exchange wall
61 first pump
62 second pump
600 cup holder unit
650 heating chamber
680 cup holder plate
71 flow regulating element
72 overpressure relief valve
73 regulating valve
74 non-return valves
75 electronic control unit
78 steam regulating element
700 hot water temperature sensor
702 steam temperature sensors
8 flow rate measurer
9 connection conduit
90 first end
99 second end
1000 coffee machine
L storage length
X prevalent flow direction
D transverse dimension

What is claimed is:

1. A dispensing group for dispensing hot water and steam, comprising:
a first fluidic conduit comprising a main branch extending between a first water inlet opening and a hot water dispensing opening, the main branch being suitable for receiving water through said first water inlet opening and allowing said water to flow towards said hot water dispensing opening;
a first heating device, operatively connected to said main branch and suitable for heating the water flowing into said main branch before the water reaches said hot water dispensing opening;
a second fluidic conduit extending between a second water inlet opening and a steam dispensing opening, said second fluidic conduit being suitable for receiving the water through said second water inlet opening and allowing said water to flow towards said steam dispensing opening; and
a second heating device, operatively connected to said second fluidic conduit and suitable for heating the water flowing into said second fluidic conduit to generate steam, before the water reaches said steam dispensing opening;
wherein the first fluidic conduit comprises a recirculation branch, which fluidically originates from said main branch downstream of the first heating device and upstream of the hot water dispensing opening and which is fluidically reintroduced into said main branch upstream of said first heating device,
and wherein said first fluidic conduit and said second fluidic conduit are fluidically and thermally separate from each other in a path thereof respectively between the first water inlet opening and the hot water dispensing opening and between the second water inlet opening and the steam dispensing opening.

2. The dispensing group of claim 1, wherein the first fluidic conduit further comprises a first pump, optionally the first pump being a rotary pump, installed upstream of the first heating device and suitable for pushing the water into the main branch towards said first heating device.

3. The dispensing group of claim 2, wherein the recirculation branch is reintroduced into the main branch upstream of said first pump.

4. The dispensing group of claim 1, wherein the main branch comprises an emission node downstream of the first heating device and upstream of the hot water dispensing opening, wherein the recirculation branch fluidically originates from the main branch at said emission node, and wherein the first fluidic conduit comprises a flow regulating element in correspondence of said emission node, suitable for regulating a water flow from the main branch towards the hot water dispensing opening or towards the recirculation branch.

5. The dispensing group of claim 4, further comprising an electronic control unit operatively connected to said flow regulating element and configured to process and send, to said flow regulating element:
a dispensing signal for allowing a passage of the water from the main branch towards the hot water dispensing opening; or
a recirculation signal for allowing a passage of the water from the main branch towards the recirculation branch.

6. The dispensing group of claim 1, further comprising a connection conduit having a first end fluidically connected to a tank suitable for containing the water, and a second end fluidically connected to the first fluidic conduit and the second fluidic conduit by the first and second water inlet openings, respectively, said connection conduit being suitable for indirectly connecting the first fluidic conduit and the second fluidic conduit to the tank.

7. The dispensing group of claim 1, further comprising a flow rate measurer installed on the first fluidic conduit.

8. The dispensing group of claim 2, wherein the main branch comprises a collection conduit, interposed between the first pump and the first heating device, suitable for accumulating water preheated by the first heating device and reintroduced into the main branch by the recirculation branch, said collection conduit being at least partially thermally conductive to allow a transmission of heat of the preheated water accumulated in the collection conduit, towards an environment.

9. The dispensing group of claim 8, wherein the collection conduit is a tube extending for a collection length along a prevalent flow direction and having a cross-section on a plane transversal to said prevalent flow direction defined by a transversal dimension, and wherein said collection length is much greater than said transversal dimension.

10. The dispensing group of claim 9, wherein the collection length is at least ten times the transversal dimension.

11. The dispensing group of claim 8, wherein the collection conduit has a snakelike development, the collection conduit forming a fluidic serpentine, comprising linear stretches interspersed with curvilinear stretches.

12. The dispensing group of claim 8, further comprising a cup holder unit positioned in proximity of the collection conduit so that heating of at least one surface of said cup holder unit is allowed by the transmission of heat from the preheated water accumulated in said collection conduit towards said cup holder unit.

13. The dispensing group of claim 8, wherein the second fluidic conduit comprises a preheating stretch passing in proximity of the collection conduit, and wherein the collection conduit allows heat to be transferred from the preheated water accumulated therein, to the preheating stretch, so as to generate a certain preheating also of the water flowing into the second fluidic conduit.

14. A coffee machine comprising a coffee dispensing unit and the dispensing group claim 1.

15. A method of recirculating preheated water, the method comprising:
a) providing a dispensing group for dispensing hot water and steam, comprising:
a first fluidic conduit comprising a main branch extending between a first water inlet opening and a hot water dispensing opening, the main branch being suitable for receiving water through said first water inlet opening and allowing said water to flow towards said hot water dispensing opening;
a first heating device, operatively connected to said main branch and suitable for heating the water flowing into said main branch before the water reaches said hot water dispensing opening;
a second fluidic conduit extending between a second water inlet opening and a steam dispensing opening, said second fluidic conduit being suitable for receiving the water through said second water inlet opening and allowing said water to flow towards said steam dispensing opening; and
a second heating device, operatively connected to said second fluidic conduit and suitable for heating the water flowing into said second fluidic conduit to generate steam, before the water reaches said steam dispensing opening,
wherein the first fluidic conduit comprises a recirculation branch which fluidically originates from said main branch downstream of the first heating device and upstream of the hot water dispensing opening and which is fluidically reintroduced into said main branch upstream of said first heating device,
and wherein said first fluidic conduit and said second fluidic conduit are fluidically and thermally separate from each other in a path thereof respectively between the first water inlet opening and the hot water dispensing opening and between the second water inlet opening and the steam dispensing opening;
b) allowing the water to pass into the main branch from the first water inlet opening towards the hot water dispensing opening;
c) by the first heating device, preheating the water flowing into said main branch to generate an amount of preheated water at a predetermined preheating temperature;
d) blocking a passage of said amount of preheated water towards the hot water dispensing opening and allowing said amount of preheated water to pass from the main branch, downstream of the first heating device, into the recirculation branch; and
e) re-introducing said amount of preheated water from the recirculation branch into the main branch upstream of said first heating device.

16. A method of dispensing hot water, the method comprising:
f) performing a method of recirculating preheated water comprising:
a) providing a dispensing group for dispensing hot water and steam, comprising:
a first fluidic conduit comprising a main branch extending between a first water inlet opening and a hot water dispensing opening, the main branch being suitable for receiving water through said first water inlet opening and allowing said water to flow towards said hot water dispensing opening;
a first heating device, operatively connected to said main branch and suitable for heating the water flowing into said main branch before the water reaches said hot water dispensing opening;
a second fluidic conduit extending between a second water inlet opening and a steam dispensing opening, said second fluidic conduit being suitable for receiving the water through said second water inlet opening and allowing said water to flow towards said steam dispensing opening; and
a second heating device, operatively connected to said second fluidic conduit and suitable for heating the water flowing into said second fluidic conduit to generate steam, before the water reaches said steam dispensing opening,
wherein the first fluidic conduit comprises a recirculation branch which fluidically originates from said main branch downstream of the first heating device and upstream of the hot water dispensing opening and which is fluidically reintroduced into said main branch upstream of said first heating device,
and wherein said first fluidic conduit and said second fluidic conduit are fluidically and thermally separate from each other in a path thereof respectively between the first water inlet opening and the hot water dispensing opening and between the second water inlet opening and the steam dispensing opening;
b) allowing the water to pass into the main branch from the first water inlet opening towards the hot water dispensing opening;
c) by the first heating device, preheating the water flowing into said main branch to generate an amount of preheated water at a predetermined preheating temperature;
d) blocking a passage of said amount of preheated water towards the hot water dispensing opening and allowing said amount of preheated water to pass from the main branch, downstream of the first heating device, into the recirculation branch; and
e) re-introducing said amount of preheated water from the recirculation branch into the main branch upstream of said first heating device;
g) providing an electronic control unit operatively connected to the dispensing group;
h) by the electronic control unit, preferably in response to a hot water dispensing command sent by a user, preferably by a user interface, sending a hot water dispensing signal to the dispensing group;
i) as a function of said hot water dispensing signal, by the first heating device, performing a final heating of a volume of water to be dispensed comprising the amount of preheated water reintroduced into the main branch and/or an amount of unheated water entering the main branch from the first water inlet opening to bring it to a predetermined dispensing temperature; and
j) allowing passage of water heated to the predetermined dispensing temperature through the hot water dispensing opening.

17. The method of claim 16, wherein step i) comprises
i1) providing a temperature sensor suitable for detecting a temperature of the water at the first heating device and operatively connected to the electronic control unit;
i2) by the electronic control unit, making a comparison between the temperature detected by said temperature sensor and a minimum preheating temperature; and
i3) as a function of said comparison, performing one of the following actions:
i31) if the temperature detected is greater than or equal to said minimum preheating temperature, heating the water by the first heating device on a maximum water flow rate, to bring the water to the predetermined dispensing temperature;
i31) if the temperature detected is less than the minimum preheating temperature, heating the water by the first heating device on a water flow rate that is lower than the maximum flow rate, to bring the water to the predetermined dispensing temperature.

18. The method of claim 16, optionally comprising, after step j), actuating the method of recirculating preheated water again, to immediately provide an amount of preheated water for a successive dispensing.

19. The dispensing group of claim 9, wherein the collection length is at least fifty times the transversal dimension.

20. The dispensing group of claim 9, wherein the collection length is at least one hundred times the transversal dimension.
